(19) United States
(12) Patent Application Publication
(10) Pub. No.: US 2009/0317657 A1
(43) Pub. Date: Dec. 24, 2009

(54) SLIDING BEARING

(76) Inventors: Christiane Knoblauch, Stuttgart (DE); Lucia Beatriz De Rizzo, Sao Paulo (BR); Jose Valentim Lima Sarabanda, Sao Paulo (BR)

Correspondence Address: COLLARD & ROE, P.C., 1077 NORTHERN BOULEVARD, ROSLYN, NY, 11576, US

(21) Appl. No.: 12/448,396

(22) PCT Filed: Dec. 14, 2007
(86) PCT No.: PCT/EP2007/010983

§ 371 Date: Aug. 31, 2009

(30) Foreign Application Priority Data
Dec. 19, 2006 (EP) EP2006/012230

(51) Int. Cl. B32B 15/01

(52) U.S. Cl. 428/647; 428/673

(57) ABSTRACT

The present invention refers to a sliding bearing (10) comprising a back metal layer (12), a bearing layer (14) applied to the back metal layer (12), a diffusion barrier layer (16) applied to the bearing layer (14) and a tin-based overlay (18a) applied to the diffusion barrier layer (16), characterized in that the diffusion barrier layer consists of one pure nickel layer (16a) applied to the bearing layer (14) and one a silver-based layer (16b) applied to the pure nickel layer (16a).

### FIELD OF INVENTION

The present invention refers to a sliding bearing comprising a back metal layer, a bearing layer applied to the back metal layer, a diffusion barrier layer applied to the bearing layer, and an overlay applied to the diffusion barrier layer.

### BACKGROUND ART

Sliding bearings manufactured as lead free composite multilayer bearings are demanded for launching of new engines, especially for medium to heavy duty engine applications. This demand goes worldwide as it is difficult to consider the development of world platforms with variations of internal components for captive markets.

A common solution being developed to the medium and heavy duty market is a composite sliding bearing based on a multilayer construction that comprises a steel backing, a lead free copper based bearing layer, an intermediate layer or diffusion barrier layer and a lead free tin-based overlay. Such bearing system is relatively close to the existing lead containing system and attempts to preserve some important functional properties of the bearings system, like the conformability and embedability given by the soft tin-based overlay with relatively preserved fatigue strength and the emergency running property of the bearing layer for the protection of the engine in the case that the overlay is completely worn out in operation. This kind of sliding bearing is for example described in the German patent application DE 103 37 030 A1.

A problem with regard to this kind of sliding bearing is the control of the tin migration or diffusion from the overlay to the copper based bearing layer that gives rise to a brittle intermetallic phase of copper-tin that leads to spalling of the overlay and seriously jeopardize the bearing load carrying capacity. DE 103 37 030 A1 discloses a diffusion barrier layer located between the overlay and the bearing layer which comprises a pure nickel layer with a thickness of 4 to 6 μm.

### OBJECTS OF THE INVENTION

It is the object of the present invention to provide a lead free sliding bearing with a tin-based overlay, which exhibits an effective control of the tin migration or diffusion from the tin-based overlay to the bearing layer. A further object of the present invention is to provide a lead free sliding bearing with a tin-based overlay, having a good conformability and good embedability properties for foreign particles during the running-in period and high load carrying capacity of the medium, especially to heavy duty engines.

### SUMMARY OF THE INVENTION

The object of the present invention is achieved by a sliding bearing with a diffusion barrier layer which consists of one pure nickel layer applied to the bearing layer and one silver-based layer applied to the pure nickel layer. The object of the present invention is further achieved by a sliding bearing with a diffusion barrier layer which consists of one pure iron layer applied to the bearing layer and one silver-based layer applied to the pure iron layer. The object of the present invention is also achieved by a sliding bearing with a diffusion barrier layer which consists of one pure nickel layer applied to the bearing layer, one layer of a tin/nickel alloy applied to the pure nickel layer and one silver-based layer applied to the layer of a tin/nickel alloy.

### BRIEF DESCRIPTION OF DRAWINGS

FIG. 1 shows a cross-section of a first embodiment of a sliding bearing according to the present invention just after manufacturing.

FIG. 2 shows a cross-section of a first embodiment of a sliding bearing according to the present invention after operating or after heat treatment.

### DETAILED DESCRIPTION OF THE INVENTION

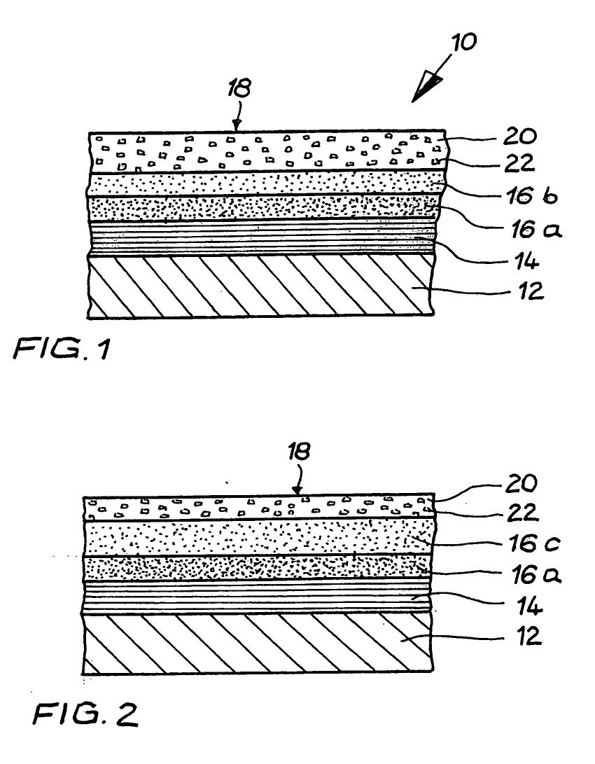

FIG. 1 shows a cross-section of a preferred embodiment of a sliding bearing 10 according to the present invention. This preferred embodiment of the sliding bearing 10 comprises a back metal layer 12, preferably made of steel, a copper-based bearing layer 14 which is for example based on a copper-tin alloy or copper-tin-nickel alloy or copper-tin-bismuth alloy or copper-tin-bismuth-nickel alloy, having a copper content of at least 85 wt %, a diffusion barrier layer consisting of two layers 16a and 16b and a tin-based overlay 18.

The overlay 18 of the present invention comprises pure tin or tin and one or more elements selected form the group comprising copper, silver, nickel, cobalt, zinc, gold, bismuth, lead or indium, preferably in a total amount of maximum 20% by weight. Tin is the main component of the overlay.

The diffusion barrier layer consists of a first layer 16a applied on the bearing layer 14. The first layer 16a is made of pure nickel or of pure iron. The first layer 16a can further be made of a layer consisting of pure nickel applied to the bearing layer 14 and of a layer consisting of a tin/nickel alloy applied on the pure nickel layer (not shown in the drawings). The diffusion barrier layer further consists of a second layer 16b. The second layer 16b is manufactured by applying a silver-based layer, preferably a pure silver layer as shown in FIG. 1, onto the surface of the first layer 16a, for example made of pure nickel. In a further embodiment (not shown) the second layer 16b consists of silver with up to 30 weight % in total of one or more elements selected from the group consisting of tin, lead, cadmium and zinc. Instead or additionally, the second layer 16b contains up to 2 weight % in total of one or more elements selected from the group consisting of antimony, iron, cobalt and nickel.

During operation of the sliding bearing for example in a combustion engine, or by heat treatment of the sliding bearing before operation, a diffusion of tin from the overlay 18 to the second layer 16b of the diffusion barrier layer takes place. Therefore, during operating, the second layer 16b is gradually transformed into a silver-tin layer 16c (see FIG. 2), mostly comprising of Ag₃Sn that replaces the layer 16b and has an increased thickness compared with the second layer 16b. Therefore, the diffusion of tin into the bearing layer 14 is effectively prevented. In addition this silver-tin layer 16c formed by diffusion of tin of the overlay 18 into the second intermediate layer 16b enhances the bonding between the diffusion barrier layer 16a plus 16c and the overlay 18. Further, the silver-tin layer 16c functions as an effective sliding layer in case that the overlay 18 is worn out completely.

In another embodiment of the invention, the sliding bearing is submitted to a heat treatment before operation. In this case the diffusion process of tin of the overlay 18 to the silver based layer 16b and the formation of the continuous silver-tin layer 16c takes place before operation. Preferably, at least 90% of the silver layer 16b is transformed into the silver-tin layer 16c. Such a heat treatment before operation is preferably done when the silver based overlay 16b is thicker than about 2 μm, because it is possible that a silver based overlay thicker than 2 μm is not completely transformed to Ag₃Sn when the transformation occurs only during operation. The heat treatment can preferably be performed at temperatures between 130° C. and 200° C. The duration of the heat treatment depends on the temperature and the thickness of the silver based layer 16b. Higher thickness of the silver based layer 16b needs higher temperature or longer duration of heat treatment (see examples in table 1 for values of time and temperature needed for the transformation of a silver based overlay 16b into a Ag₃Sn-overlay 16c). A very long heat treatment is not preferable with regard to the costs. High temperatures also are not preferable due to the risk of further diffusion processes causing embrittlement of the layers. A too low temperature, for example 100° C. is not preferred, because in this case the transformation takes much more time. Also it is not preferable to transform a too small part of the silver based layer 16b, preferably less than 90%, into the Ag₃Sn-overlay 16c, because the remaining silver may be corroded, causing the failure of the bearing as a consequence. The heat treatment is preferably performed with the following parameters as shown in table 2.

For these reasons the silver based layer 16b preferably has a thickness of 1 to 5 μm. Thick layers 16b take much more time for the transformation into the Ag₃Sn layer 16c. Thin layers 16b might be not tight enough and therefore less effective.

TABLE 1
Thickness of Ag₃Sn-layer 16c formed by diffusion of Sn
from the overlay 18 into the silver based layer 16b.

| | no heat | | | |
|---|---|---|---|---|
| time | treatment | 100° C. | 150° C. | 200° C. |
| | 0.3 | | | |
| 1 h | | | 0.5 | 1.4 |
| 2 h | | | 0.7 | |
| 5 h | | | 0.8 | 2.9 |
| 10 h | | 0.5 | 1.1 | 5 |
| 15 h | | | 1.4 | |
| 20 h | | 0.6 | 1.5 | |
| 50 h | | 0.6 | | |
| 116 h | | | 5 | 10 |

Values are given in μm.

TABLE 2
Preferred heat treatment for transformation of
silver based layer 16b of a certain thickness

| Thickness of layer 16b | Heat treatment |
|---|---|
| ip to 1.5 μm | 150° C., 10 h |
| 1.5 to 3 μm | 200° C., 5 h |
| 3 to 5 μm | 200° C., 10 h |

For both embodiments—with or without heat treatment before operation—the silver-tin layer 16c is formed regardless of the composition of the tin-based overlay 18. Preferably, the overlay 18 contains not more than about 20 weight % in total of alloying elements. In case that the tin-based overlay 18 contains more than 20 weight % of alloying elements, the duration of formation of the silver-tin layer 16c is longer because the diffusion of tin from the overlay 18 to the silver based layer 16b is slower. Therefore, the present invention is useful with regard to every tin-based overlay 18, but preferably with an amount of alloying elements less than 20 wt %.

Preferably the silver-tin layer 16c can be described as the c-phase of a tin-silver binary phase with a compound description as Ag₃Sn and characterized by X-ray diffraction.

The presence of the silver-tin layer 16c that is formed by gradual transformation of the second layer 16b decreases the diffusion of tin to the first layer 16a and the bearing layer 14 hindering the formation of a brittle copper-tin phase at the interface of a copper-based bearing layer 14. As it is known from the prior art, such embrittlement process leads to overlay spalling or to serious degradation of its fatigue resistance. With the formation of a continuous silver-tin layer by transformation of the second layer 16b on the top of the first layer 16a, it was observed a strong decrease of the tin migration to the first layer 16a. The silver-tin layer 16c obviously becomes an efficient diffusion controlling barrier.

An other function of a continuous silver-tin layer 16c is to become itself a hard high wear resistant sliding layer with improved scuffing and fatigue resistance after the worn out of the softer tin-based overlay 18.

Eventually, at the loaded areas of heavy duty applications there may happen a fatigue wear process of the tin-based overlay 18a with the exposure of the silver-tin layer 16c. Under such condition, the hard, highly seizure and fatigue resistant silver-tin layer 16c gives an enduring full protection to the bearing operation. The preservation of the tin-based overlay 18a at the regions less loaded gives a continuous embedability and represents a protection against wear of the silver-tin layer 16c exposed at the loaded area.

1. Sliding bearing (10) comprising a back metal layer (12), a bearing layer (14) applied to the back metal layer (12), a diffusion barrier layer (16) applied to the bearing layer (14) and an overlay (18) applied to the intermediate layer (16), wherein the diffusion barrier layer (16) consists of one pure nickel layer (16a) applied to the bearing layer (14) and one silver-based layer (16b) applied to the pure nickel layer (16a).

2. Sliding bearing (10) comprising a back metal layer (12), a bearing layer (14) applied to the back metal layer (12), a diffusion barrier layer (16) applied to the bearing layer (14) and an overlay (18) applied to the intermediate layer (16), wherein the diffusion barrier layer (16) consists of one pure iron layer (16a) or a first layer of nickel and a second layer of tin/nickel alloy applied to the bearing layer (14) and one silver-based layer (16b) applied to the layer (16a).

3. Sliding bearing according to claim 1, wherein the silver-based layer (16b) contains pure silver.

4. Sliding bearing according to claim 1, wherein the silver based layer (16b) contains silver and one or more elements selected from the group consisting of tin, lead, cadmium and zinc preferably in an amount of up to 30 weight %.

5. Sliding bearing according to claim 1, wherein the silver based layer (16b) contains silver and one or more elements selected from the group consisting of antimony, iron, cobalt and nickel, preferably in an amount of up to 2 weight %.

6. Sliding bearing according to claim 1, wherein the thickness of the silver based layer (16b) is from 0.5 to 10.0 μm, preferably from 1.0 to 5.0 μm.

7. Sliding bearing according to claim 1, wherein the overlay (18) has least the same thickness than the silver based layer (16b).

8. Sliding bearing according to claim 1, wherein the thickness of the overlay (18) is from 2.0 to 30.0 μm.

9. Sliding bearing according to claim 1, wherein the silver-based layer (16b) contains a silver-tin intermetallic phase.

10. Sliding bearing according to claim 9, wherein the silver-tin intermetallic phase is Ag₃Sn.

11. Sliding bearing according to claim 1, wherein the overlay (18) comprises pure tin or tin with one or more elements selected form the group consisting of copper, silver, nickel, cobalt, zinc, gold, bismuth, lead or indium.

12. Sliding bearing according to claim 11, wherein the overlay (18) contains the one or more elements in a total amount of 20 wt %.

13. Sliding bearing according to claim 1, wherein the bearing layer (14) is a copper-based bearing layer.

14. Sliding bearing according to claim 13, wherein the bearing layer (14) has a copper content of at least 85 wt %.

15. Sliding bearing according to claim 13, wherein the bearing layer (14) further contains tin and/or nickel and/or bismuth.

16. Use of a sliding bearing according to claim 1 in a combustion engine.
